(19) United States
(12) Patent Application Publication
(10) Pub. No.: US 2013/0228669 A1
(43) Pub. Date: Sep. 5, 2013

(54) MOUNTING APPARATUS FOR FAN

(71) Applicants: HONG FU JIN PRECISION INDUSTRY (SHENZHEN) CO., LT, Shenzhen (CN); HON HAI PRECISION INDUSTRY CO., LTD., New Taipei (TW)

(72) Inventor: FU-MING LIU, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/685,629

(22) Filed: Nov. 26, 2012

(30) Foreign Application Priority Data
Mar. 5, 2012 (CN) 201210054999.9

(51) Int. Cl. F16M 13/02

(52) U.S. Cl. CPC F16M 13/02
USPC 248/674

(57) ABSTRACT

A mounting apparatus includes a chassis and a securing member. The chassis includes a side plate. A supporting flange extends from the side plate, and a first mounting structure is located on the side plate. The securing member, configured to secure a fan to the side plate, comprises a latch and a second mounting structure, which are resiliently deformable. The latch is engaged with the supporting flange, and the second mounting structure is engaged with the first mounting structure.

### BACKGROUND

1. Technical Field

The present disclosure relates to mounting apparatuses, and particularly to a mounting apparatus for a fan.

2. Description of Related Art

In a computer system, fans are provided to dissipate heat from the computer system. The fans are often secured in the computer system by screws. However, the conventional securing method for the fans is inconvenient and time-consuming.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a mounting apparatus and a fan in accordance with an embodiment.

FIG. 2 is an isometric view of a securing member of the mounting apparatus of FIG. 1.

FIG. 3 is an exploded, isometric, cutaway view of a chassis and an assembly of the securing member and a fan of the mounting apparatus of FIG. 1.

FIG. 4 is a cutaway view of the assembly of the mounting apparatus and the fan of FIG. 3.

FIG. 5 is a cross sectional, cutaway view of the assembly of the mounting apparatus and the fan of FIG. 4, taken along a line V-V.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

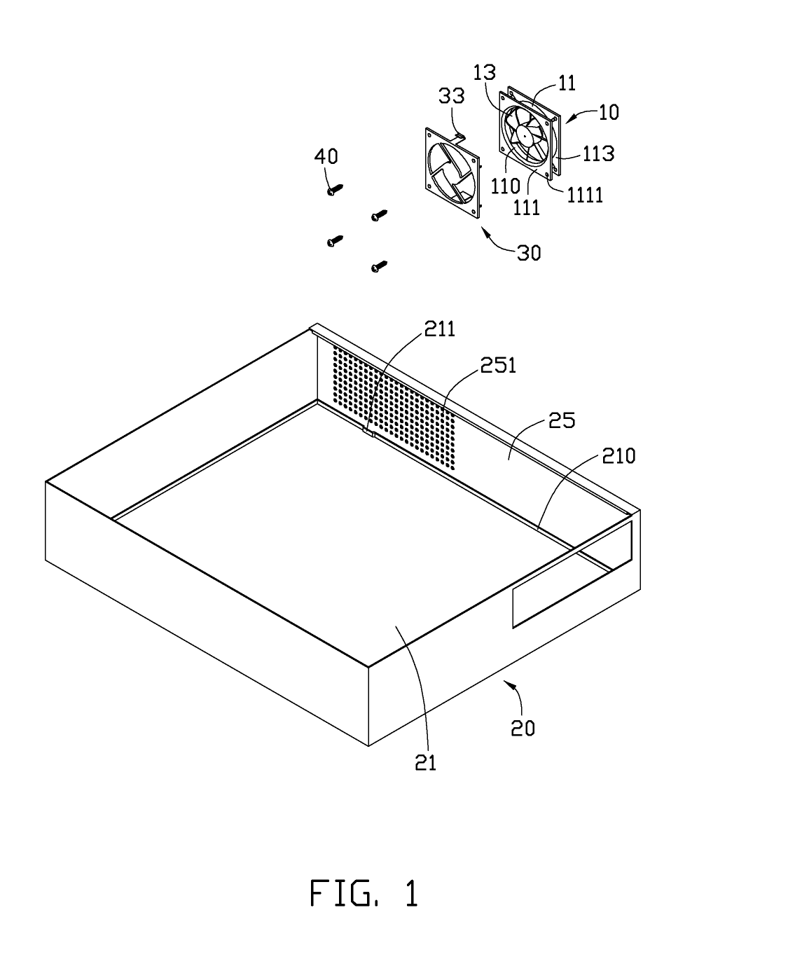

FIGS. 1-5 illustrate a mounting apparatus in accordance with an embodiment for mounting a fan 10. The fan 10 comprises a body 13, a first sidewall 111, a second sidewall 113, and a connecting portion 11 connected to and located between the first sidewall 111 and the second sidewall 113. The connecting portion 11 defines a receiving space 110, which receives the fan body 13 of the fan 10.

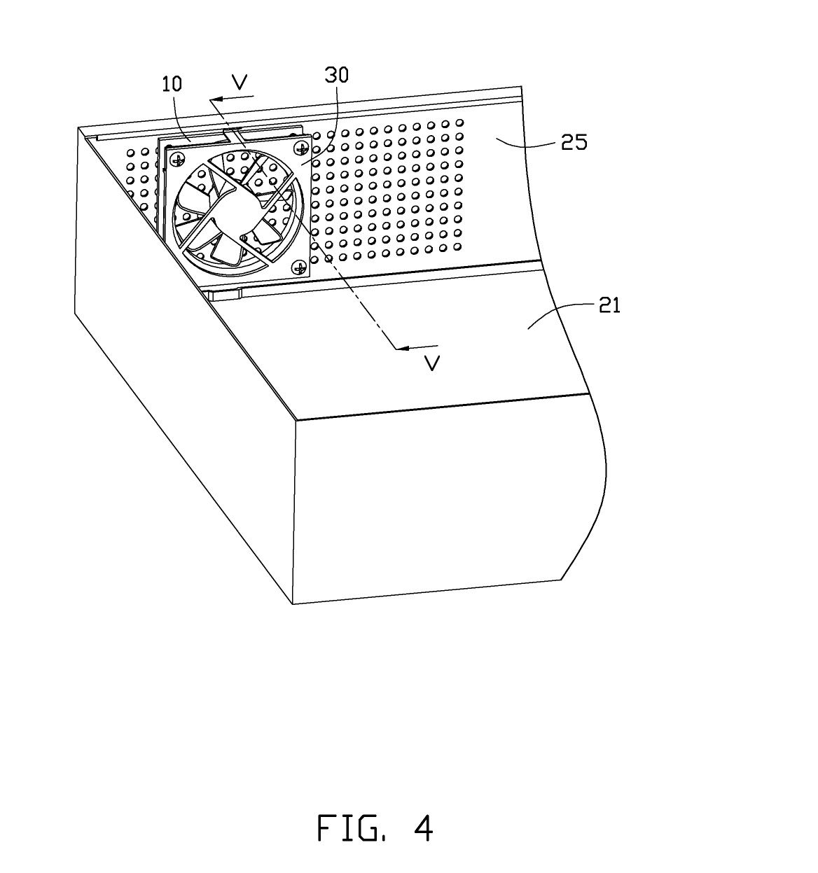

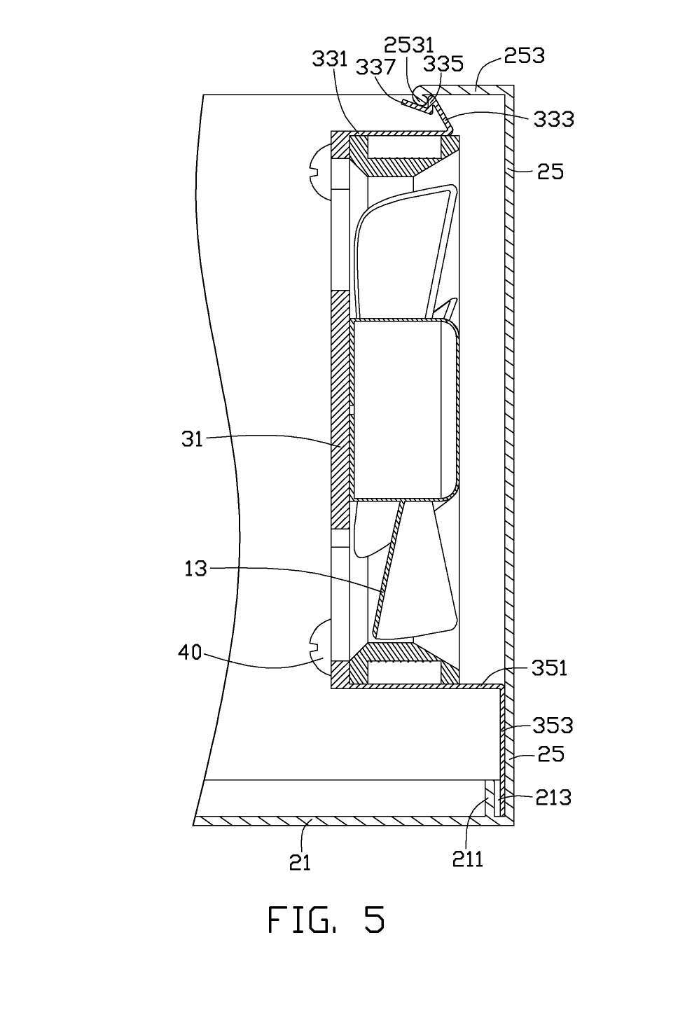

The mounting apparatus comprises a chassis 20 and a securing member 30. The chassis 20 comprises a side plate 25. A supporting flange 253 extends from the side plate 25. A first mounting structure 211 is located on the side plate 25. The securing member 30, which is configured to secure the fan 10 to the side plate 25, comprises a latch 33 and a second mounting structure 35, which are resiliently deformable. FIGS. 4-5 show that the fan 10 is secured to the side plate 25, the latch 33 is engaged with the supporting flange 253, and the second mounting structure 35 is engaged with the first mounting structure 211.

FIG. 5 shows that a blocking portion 2531 is located on the supporting flange 253, and the latch 33 abuts against the blocking portion 2531, to prevent the latch 33 from being disengaged from the supporting flange 253. In an embodiment, the blocking portion 2531 extends from the supporting flange 253.

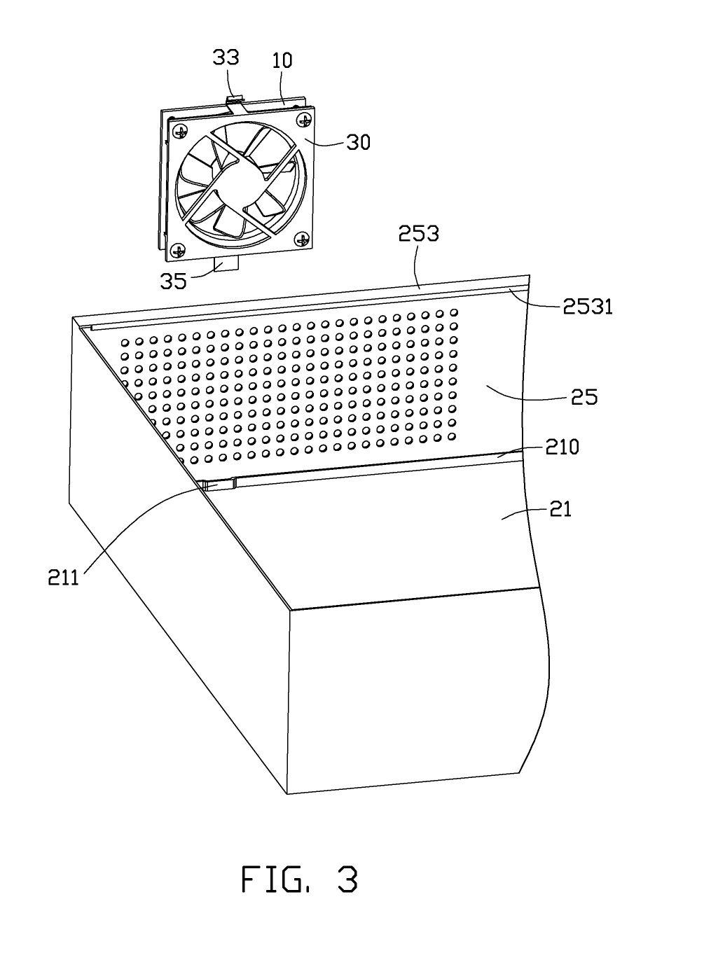

FIGS. 1 and 3 show that a locking flange 210 extends from the side plate 25, and the first mounting structure 211 is located on the locking flange 210. A gap 213 is defined between the side plate 25 and the first mounting structure 211, and the second mounting structure 35 is engaged in the gap 213 (shown in FIG. 5) when the fan 10 is secured to side plate 25. In an embodiment, the supporting flange 253 and the locking flange 210 extend from opposite edges of the side plate 25.

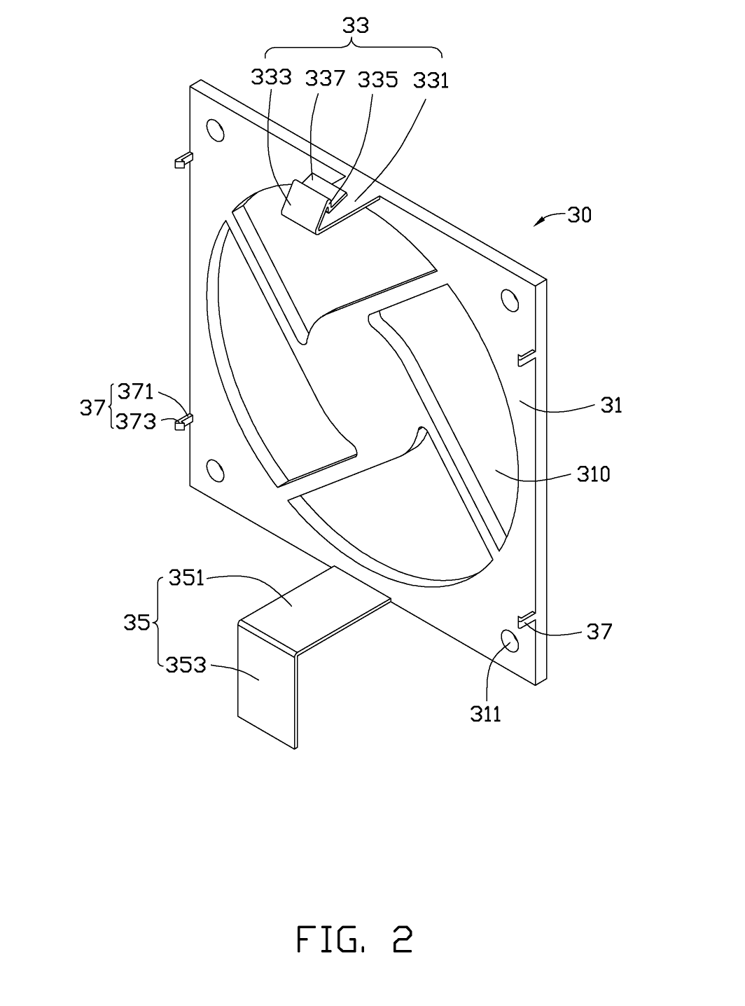

FIG. 2 shows that the securing member 30 further comprises a main body 31, and the main body 31 defines a plurality of through openings 310. The latch 33 and the second mounting structure 35 extend from the main body 31. The latch 33 comprises a first extending piece 331, a second extending piece 333, a third extending piece 335, and a fourth extending piece 337. The first extending piece 331 extends from the main body 31. The second extending piece 333 extends upwards from the first extending piece 331. The third extending pieces 335 extends downwards from the second extending piece 333. The fourth extending piece 337 extends upwards from the third extending piece 335. When the securing member 30 is secured to the side plate 25, the third extending piece 335 abuts the blocking portion 2531. In an embodiment, the first extending piece 331 is substantially perpendicular to the main body 31. A first acute angle is defined between the first extending piece 331 and the second extending piece 333. A second acute angle is defined between the second extending piece 333 and the third extending piece 335, and a third acute angle is defined between the third extending piece 335 and the fourth extending piece 337.

FIG. 2 shows that the second mounting structure 35 comprises a first mounting piece 351, extending from the main body 31, and a second mounting piece 353, extending from the first mounting piece 351. The second mounting piece 353 is engaged in the gap 213. In an embodiment, the first mounting piece 351 is substantially perpendicular to the second mounting piece 353.

Referring to FIGS. 1 and 3-5, the chassis 20 further comprises a bottom plate 21. The side plate 25 is located on the bottom plate 21. In an embodiment, the side plate 25 is substantially perpendicular to the bottom plate 21, the main body 31 of the securing member 30 is substantially parallel to the side plate 25, the first mounting piece 351 is substantially perpendicular to the side plate 25, and the second mounting piece 353 is substantially perpendicular to the bottom plate 21.

FIGS. 1-3 and 5 show that the securing member 30 further comprises a plurality of hooks 37 located on the main body 31, and the plurality of hooks 37 are configured to engage with the first sidewall 111 of the fan 10. The main body 31 of the securing member 30 defines a plurality of through holes 311. The first sidewall 111 of the fan 10 defines a plurality of mounting holes 1111. A plurality of fasteners 40, such as screws, are fixed into the plurality of through holes 311 and the plurality of mounting holes 1111, to secure the securing member 30 to the fan 10.

FIGS. 3-5 shows that for example, after the fan 10 is assembled to the securing member 30 by the hooks 37 and the fasteners 40, the assembly of the securing member 30 and the fan 10 is moved in the chassis 20. The second mounting piece 353 of the second mounting structure 35 is inserted in the gap 213, and then the assembly of the securing member 30 and the fan 10 is rotated to move the latch 33 towards the supporting flange 253 of the side plate 25. When the blocking portion 2531 of the supporting flange 253 presses the second extending piece 333, the latch 33 is resiliently deformed, until the second extending piece 333 passes across the blocking portion 2531, and then the latch 33 rebounds back to engage with the supporting flange 253. The third extending piece 335 abuts the blocking portion 2531 and the fan 10 is thus secured to the side plate 25. When the fan 10 operates, airflow flows out of the chassis 20 via the plurality of through openings 310 and the plurality of ventilation holes 251.

When the latch 33 of the securing member 30 is resiliently deformed to disengage third extending piece 335 from the blocking portion 2531 of the supporting flange 253, the assembly of the securing member 30 and the fan 10 can be rotated away from the side plate 25. The second mounting piece 353 of the second mounting structure 35 can be removed from the gap 213. Therefore, the assembly of the securing member 30 and the fan 10 can be removed out of the chassis 20.

In another embodiment, the first mounting structure 211 can be located on the bottom plate 21, and the locking flange 210 extends from the bottom plate 21.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A mounting apparatus, comprising:
a chassis comprising a side plate, a supporting flange extending from the side plate, and a first mounting structure located on the side plate; and
a securing member configured to secure a fan to the side plate, the securing member comprises a latch and a second mounting structure, which are resiliently deformable, the latch is engaged with the supporting flange, and the second mounting structure is engaged with the first mounting structure.

2. The mounting apparatus of claim 1, wherein a blocking portion is located on the supporting flange, and the latch abuts the blocking portion, to prevent the latch disengaged from the supporting flange.

3. The mounting apparatus of claim 2, wherein the blocking portion extends from the supporting flange.

4. The mounting apparatus of claim 2, wherein a locking flange extends from the side plate, and the first mounting structure is located on the locking flange.

5. The mounting apparatus of claim 4, wherein the supporting flange and the locking flange extend from opposite edges of the side plate.

6. The mounting apparatus of claim 4, wherein a gap is defined between the side plate and the first mounting structure, and the second mounting structure is engaged in the gap.

7. The mounting apparatus of claim 6, wherein the securing member further comprises a main body, and the latch and the second mounting structure extend from the main body.

8. The mounting apparatus of claim 7, wherein the latch comprises a first extending piece, a second extending piece, a third extending piece, and a fourth extending piece; and the first extending piece extends from the main body, the second extending piece extends upwards from the first extending piece, the third extending pieces extends downwards from the second extends piece, the fourth extending piece extends upwards from the third extends piece, and the third extending piece abuts the blocking portion.

9. The mounting apparatus of claim 8, wherein the first extending piece is substantially perpendicular to the main body, a first acute angle is defined between the first extending piece and the second extending piece, a second acute angle is defined between the second extending piece and the third extending piece, and a third acute angle is defined between the third extending piece and the fourth extending piece.

10. The mounting apparatus of claim 7, wherein the second mounting structure comprises a first mounting piece extending from the main body and a second mounting piece extending from the first mounting piece, and the second mounting piece is engaged with the gap.

11. The mounting apparatus of claim 10, wherein the first mounting piece is substantially perpendicular to the second mounting piece.

12. The mounting apparatus of claim 7, wherein the securing member further comprises a plurality of hooks located on the main body, and the plurality of hooks are configured to engage with the fan.

13. A mounting apparatus, comprising:
a chassis comprising a bottom plate and a side plate located on the bottom plate, a supporting flange extending from the side plate, and a first mounting structure located on the bottom plate; and
a securing member configured to secure a fan to the side plate, the securing member comprises a latch and a second mounting structure, which are resiliently deformable, the latch is engaged with the supporting flange, and the second mounting structure is engaged with the first mounting structure.

14. The mounting apparatus of claim 13, wherein a blocking portion extends from the supporting flange, and the latch abuts the blocking portion to prevent the latch disengaged from the supporting flange.

15. The mounting apparatus of claim 13, wherein a locking flange extends from the side plate, the supporting flange and the locking flange extend from opposite edges of the side plate, and the first mounting structure is located on the locking flange.

16. The mounting apparatus of claim 15, wherein a gap is defined between the side plate and the first mounting structure, and the second mounting structure is engaged in the gap.

17. The mounting apparatus of claim 16, wherein the securing member further comprises a main body, and the latch and the second mounting structure extend from the main body.

18. The mounting apparatus of claim 17, wherein the latch comprises a first extending piece, a second extending piece, a third extending piece, and a fourth extending piece; and
the first extending piece extends from the main body, the second extending piece extends upwards from the first extending piece, the third extending pieces extends downwards from the second extends piece, and the fourth extends upwards from the third extends piece.

19. The mounting apparatus of claim 18, wherein the first extending piece is substantially perpendicular to the main body, a first acute angle is defined between the first extending piece and the second extending piece, a second acute angle is defined between the second extending piece and the third extending piece, and a third acute angle is defined between the third extending piece and the fourth extending piece.

20. The mounting apparatus of claim 19, wherein the side plate is substantially perpendicular to the bottom plate, the main body is substantially parallel to the side plate, the second mounting structure comprises a first mounting piece extending from the main body and a second mounting piece substantially perpendicularly extending from the first mounting piece, the first mounting piece is substantially perpendicular to the side plate, and the second mounting piece is substantially perpendicular to the bottom plate and engaged in the gap.
